(19) United States
(12) Patent Application Publication
(10) Pub. No.: US 2015/0261280 A1
(43) Pub. Date: Sep. 17, 2015

(54) APPARATUSES AND METHODS FOR WAKING A DISPLAY WITH AN ADJUSTABLE POWER LEVEL TO DETECT TOUCHES THEREON

(71) Applicant: MediaTek Inc., Hsin-Chu (TW)

(72) Inventors: Chih-Hsiang HSIAO, Taipei City (TW); Chung-Jen KUO, Hsin-Chu City (TW); Jih-Ming HSU, Zhongli City (TW)

(73) Assignee: MediaTek Inc., Hsin-Chu (TW)

(21) Appl. No.: 14/215,419

(22) Filed: Mar. 17, 2014

(51) Int. Cl. G06F 1/32; G06F 3/01; G06F 3/041

(52) U.S. Cl. CPC G06F 1/3218; G06F 3/0416; G06F 3/017

(57) ABSTRACT

A portable electronic device including a touch sensor and a processing unit is provided. The touch sensor is disposed on or under a display, and uses a power level to generate first touch data for a touch detected thereon when the display is in a sleep state. The processing unit configures the touch sensor to increase the power level to generate second touch data for the touch when determining that the touch corresponds to a predetermined gesture with a first similarity probability greater than a first threshold according to the first touch data, and wakes the display from the sleep state when determining that the touch corresponds to the predetermined gesture with a second similarity probability greater than a second threshold according to the second touch data, wherein the second threshold is greater than the first threshold.

### BACKGROUND OF THE INVENTION

1. Field of the Invention

The invention generally relates to the field of touch detection, and more particularly, to apparatuses and methods for waking a display with an adjustable power level to detect touches thereon.

2. Description of the Related Art

To an increasing extent, touch screens are being used as an alternative way for users to interact with portable electronic devices, such as touch books, mobile phones, panel PCs, media player devices, and gaming devices, etc. In addition to providing basic display function, a touch screen further comprises one or more touch sensors for detecting the contact of objects thereon, thereby providing alternatives for user interaction therewith, for example, by using pointers, styluses, fingers, etc. In most practices, when the user does not interact with the portable electronic device for a certain period of time, the touch screen may enter a sleep state in which both the display function and the touch-detection function are shut down for saving power. Later, the user may press a specific button on the portable electronic device to wake the touch screen from the sleep state. In another practice, the touch screen may be configured to enter the sleep state in which only the display function is shut down while the touch-detection function is still working, and the user may wake the touch screen from the sleep state by simply tapping on the touch screen or touching to form a particular gesture on the touch screen.

However, in the latter practice, the higher power consumption needed to keep the touch-detection function always on would be a huge disadvantage since the power of the portable electronic device is rather limited. Thus, it is desirable to have a more flexible way of touch detection with screen off to sustain a long standby time of the portable electronic device while keeping accuracy of the touch detection.

### BRIEF SUMMARY OF THE INVENTION

In one aspect of the invention, a portable electronic device is provided. The portable electronic device comprises a touch sensor and a processing unit. The touch sensor is disposed on or under a display, and uses a power level to generate first touch data for a touch detected thereon when the display is in a sleep state. The processing unit configures the touch sensor to increase the power level to generate second touch data for the touch when determining that the touch corresponds to a predetermined gesture with a first similarity probability greater than a first threshold according to the first touch data, and wakes the display from the sleep state when determining that the touch corresponds to the predetermined gesture with a second similarity probability greater than a second threshold according to the second touch data, wherein the second threshold is greater than the first threshold.

In another aspect of the invention, a method for a portable electronic device to wake a display with a touch sensor disposed thereon or thereunder is provided. The method comprises the steps of: configuring the touch sensor to use a power level to generate first touch data for a touch detected on the display when the display is in a sleep state; configuring the touch sensor to increase the power level to generate second touch data for the touch when determining that the touch corresponds to a predetermined gesture with a first similarity probability greater than a first threshold according to the first touch data; and waking the display from the sleep state when determining that the touch corresponds to the predetermined gesture with a second similarity probability greater than a second threshold according to the second touch data, wherein the second threshold is greater than the first threshold.

In yet another aspect of the invention, a method for a portable electronic device to wake a display with a touch sensor disposed thereon or thereunder is provided. The method comprises the steps of: detecting, by the touch sensor, a valid touch on the display when the display is in a sleep state; while the valid touch continues to be detected, dynamically adjusting a power level provided to the touch sensor in accordance with a similarity between the valid touch and a predetermined gesture, wherein the similarity changes with time; and when a termination condition for detecting the valid touch is satisfied, determining whether to wake the display from the sleep state according to a type of the termination condition.

Other aspects and features of the invention will become apparent to those with ordinary skill in the art upon review of the following descriptions of specific embodiments of the portable electronic device, and the method for a portable electronic device to wake a display with a touch sensor disposed thereon or thereunder.

### BRIEF DESCRIPTION OF DRAWINGS

The invention can be more fully understood by reading the subsequent detailed description and examples with references made to the accompanying drawings, wherein:

FIG. 1 is a block diagram of a portable electronic device according to an embodiment of the invention;

FIG. 2 is a flow chart illustrating the method for waking a display with a dynamically adjustable power level to detect touches thereon according to an embodiment of the invention;

FIG. 3 is a block diagram illustrating an exemplary function blocks for carrying out the method of the invention;

FIG. 4 is an exemplary diagram showing four power levels for four different detection modes determined according to the similarity probability;

FIG. 5 is a flow chart illustrating adjustment of the detection modes according to the embodiment in FIG. 4;

FIGS. 6A to 6C show schematic diagrams illustrating the waking of the touch screen of a smart phone from the sleep state in accordance with the embodiment of FIG. 4; and

FIG. 7 is a flow chart illustrating the method for waking a display with a dynamically adjustable power level to detect touches thereon according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

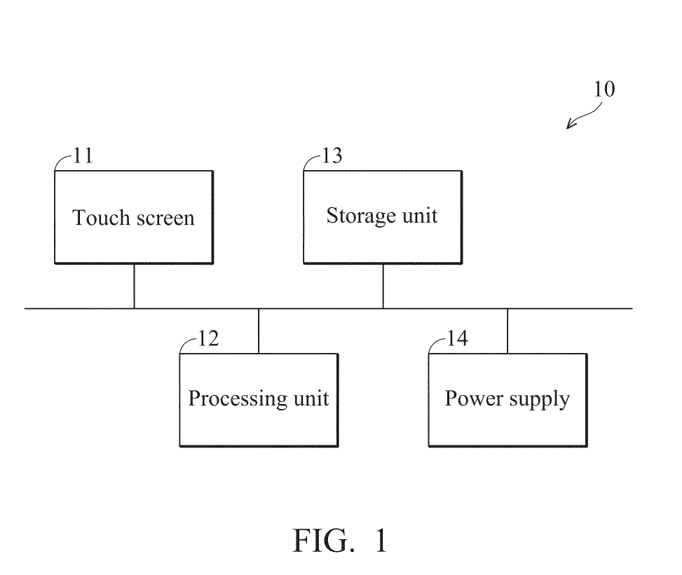

FIG. 1 is a block diagram of a portable electronic device according to an embodiment of the invention. The portable electronic device 10 comprises a touch screen 11, a processing unit 12, a storage unit 13, and a power supply 14. The touch screen 11 is sensitive to touches, contacts, or approximations of objects, such as fingers or styluses. Specifically, the touch screen 11 may comprise a display (not shown), such as a Liquid Crystal Display (LCD), Light-Emitting Diode (LED) display, or Electronic Paper Display (EPD), etc., for providing display function, and one or more touch sensors (not shown) disposed on or under the display for providing touch-detection function, wherein the touch-detection function may include resistive type, capacitive type, or other types of touch detection. The processing unit 12 may be a general-purpose processor, a Micro-Control Unit (MCU), a Digital Signal Processor (DSP), or others, which provides the function of data processing and computing, and controls the operation of the touch screen 11, and loads and executes a series of instructions and/or program codes from the storage device 13 to perform the method of the invention for waking the touch screen 11 with an adjustable power level to detect touches thereon. For example, the processing unit 12 may be a Central Processing Unit (CPU), or a controller of a touch Integrated Circuit (IC), or a controller of a sensor hub which incorporates all sensing units including the touch sensors. The power supply 14 may be a portable/replaceable and chargeable battery, which provides power to the other functional units, including the touch screen 11, the processing unit 12, and the storage unit 13, and allows portability of the portable electronic device 10. However, the power provided by the power supply 14 is limited when the portable electronic device 10 is not being charged. The portable electronic device 10 may be a touch book, mobile/smart phone, panel PC, Portable Media Player (PMP), global positioning system (GPS) navigation device, portable gaming console, and so on.

Although not shown, the portable electronic device 10 may further comprise other functional units, such as a Radio Frequency (RF) unit and a Baseband unit for wireless communications, and/or an Input/Output (I/O) device, e.g., button, keyboard, mouse, or touch pad, etc., and the invention is not limited thereto. Taking the portable electronic device 10 being a mobile/smart phone as an example, the Baseband unit may contain multiple hardware devices to perform baseband signal processing, including Analog-to-Digital Conversion (ADC)/Digital-to-Analog Conversion (DAC), gain adjusting, modulation/demodulation, encoding/decoding, and so on, while the RF unit may receive RF wireless signals, convert the received RF wireless signals to baseband signals, which are processed by the Baseband unit, or receive baseband signals from the baseband unit and convert the received baseband signals to RF wireless signals, which are later transmitted. The RF unit may also contain multiple hardware devices to perform radio frequency conversion, such as a mixer for multiplying the baseband signals with a carrier oscillated in the radio frequency of the wireless communications system, wherein the radio frequency may be 900 MHz, 1800 MHz or 1900 MHz utilized in GSM systems, or may be 900 MHz, 1900 MHz or 2100 MHz utilized in WCDMA systems, or others depending on the Radio Access Technology (RAT) in use.

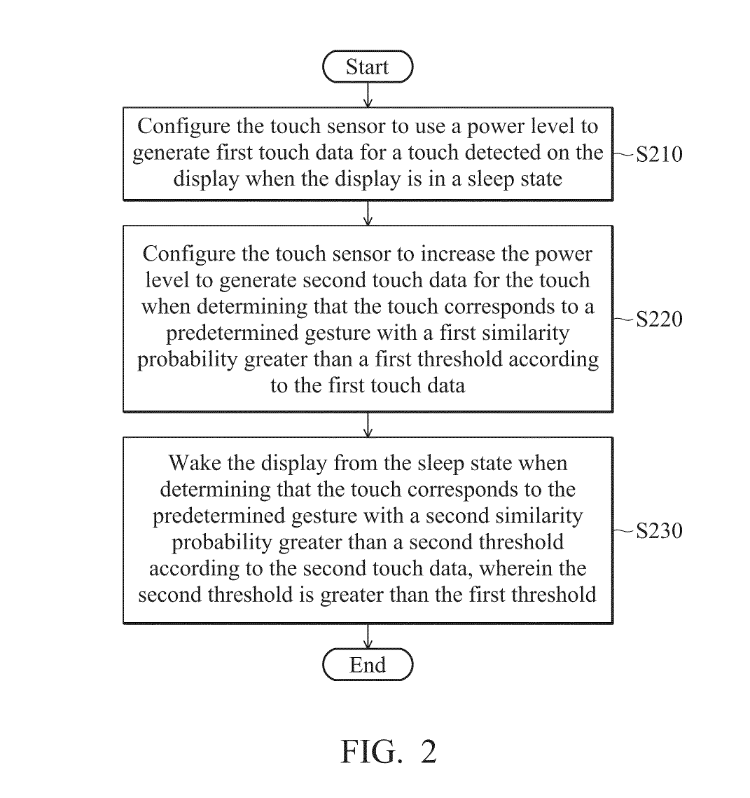

FIG. 2 is a flow chart illustrating the method for waking a display with a dynamically adjustable power level to detect touches thereon according to an embodiment of the invention. In this embodiment, the method is applied to a portable electronic device comprising a display with a touch sensor disposed thereon or thereunder. To begin, the portable electronic device configures the touch sensor to use a power level to generate first touch data for a touch detected on the display when the display is in a sleep state (step S210). That is, the power level is used to generate the first touch data when the touch is detected on the display in the sleep state. In one embodiment, prior to step S210, the portable electronic device may configure the touch sensor to use a standby power level for detecting whether the display is touched, wherein the standby power level is lower than the power level for saving power.

Next, the portable electronic device configures the touch sensor to increase the power level to generate second touch data for the touch when determining that the touch corresponds to a predetermined gesture with a first similarity probability greater than a first threshold according to the first touch data (step S220). When determining that the touch corresponds to the predetermined gesture with a second similarity probability greater than a second threshold according to the second touch data, the portable electronic device wakes the display from the sleep state, wherein the second threshold is greater than the first threshold (step S230). That is, the touch continues for a period of time so that the touch detection is kept updated to identify whether the touch forms a gesture that matches the predetermined gesture, and if high similarity is signified based on the touch data and the thresholds, the power level used is increased to provide better accuracy or quality of the touch detection.

The first similarity probability and second similarity probability indicate how similar the touch is to the predetermined gesture based on the first touch data and the second touch data, respectively. The first touch data may be construed to be generated at a certain time, and as the touch continues over time, the second touch data may be construed to be generated at a later time. The first similarity probability and the second similarity probability may be determined by analyzing the spatial trace and/or the duration of the touch and comparing the analyzed result with the predetermined gesture.

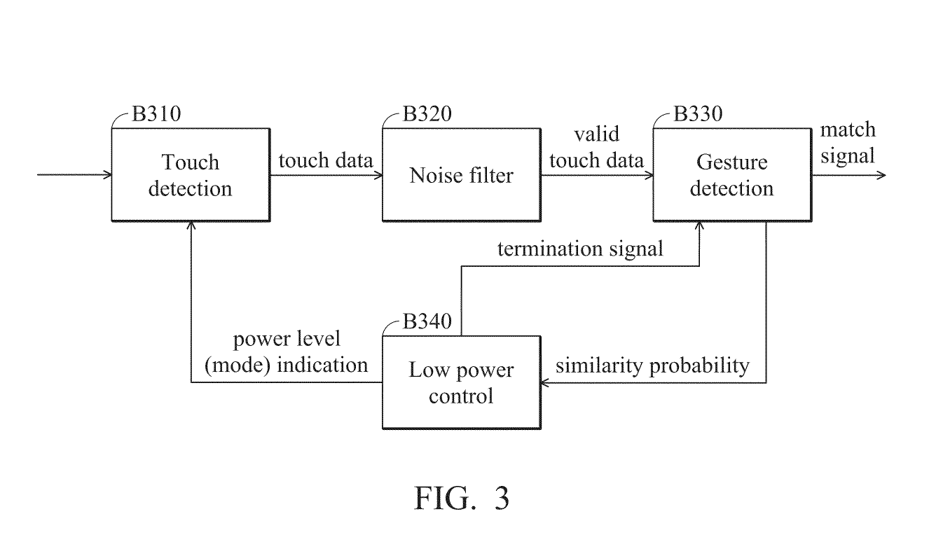

FIG. 3 is a block diagram illustrating an exemplary function blocks for carrying out the method of the invention. The block B310 is responsible for generating touch data with an adjustable power level configured by block B340. The block B320 is responsible for identifying whether the touch data generated by the block B310 is noise and filtering out the noise. Specifically, the touch data is identified as noise if the touch data indicates that the touch is not detected within a Region Of Interest (ROI) on the touch screen 11, or that the touch is detected within a certain distance to the edge of the touch screen 11 (i.e., too close to the edge). Alternatively, the touch data is identified as noise if the touch data indicates that the area covered by the touch on the touch screen 11 is not within a predetermined range. For example, assuming that a finger touch generally crosses 5 sensing lines on the touch screen 11, the detected touch may be identified as noise if it crosses less than 2 sensing lines.

The block B330 is responsible for gesture detection to determine one or more similarity probabilities of how similar the touch is to one or more predetermined gestures. Each predetermined gesture may be a letter, e.g., ‘A’, ‘B’, ‘C’, . . . , or ‘Z’, or a symbol, e.g., a check mark, star sign, or pound sign, etc., or others. If the similarity probability or one of the similarity probabilities is greater than a threshold, a match is identified and a signal is sent to the operating system of the portable electronic device 10. Otherwise, the similarity probability or probabilities are sent to the block B340.

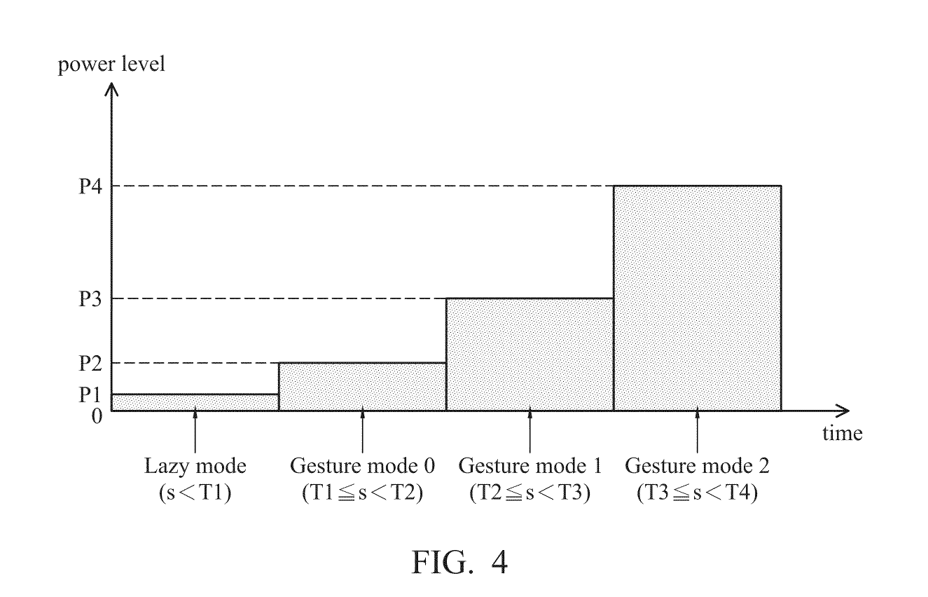

The block B340 is responsible for determining whether to adjust the power level used for touch detection in the block B310 or whether to terminate the gesture detection for the currently detected touch, according to the similarity probability or probabilities. Specifically, there may be several thresholds configured for the similarity probability or probabilities, which are used to determine the target detection mode. For example, 4 thresholds may be configured for 4 different detection modes in which 4 different power levels are provided, as shown in FIG. 4. If the similarity probability s is lower than the threshold T1, a lazy mode is configured in which the power level P1 (i.e., the standby power level) is provided to support the sampling rate of 40 Hz for detecting whether the touch screen 11 is touched or not. If the similarity probability s is greater than or equal to the threshold T1 and less than the threshold T2, a gesture mode 0 is configured in which the power level P2 is provided to support the sampling rate of 10 Hz for one finger detection. If the similarity probability s is greater than or equal to the threshold T2 and less than the threshold T3, a gesture mode 1 is configured in which the power level P3 is provided to support the sampling rate of 40 Hz for one finger detection. If the similarity probability s is greater than or equal to the threshold T3 and less than the threshold T4, a gesture mode 2 is configured in which the power level P4 is provided to support the sampling rate of 75 Hz for one finger detection. At last, if the similarity probability s is greater than or equal to the threshold T4, a match is identified.

Please note that, the power level may be increased or decreased dynamically depending on whether the similarity probability is growing or dropping from one threshold to another. For example, if the similarity probability is dropping from above the threshold T2 to under the threshold T2, the power level may be decreased from P3 to P2. In addition, the power level may be adjusted so that the detection mode switches across one or more modes. For example, the detection mode may be switched from gesture mode 0 to gesture mode 2, or the detection mode may be switched from gesture mode 2 to lazy mode, depending on the difference of two successive similarity probabilities in time.

It is to be understood that, due to the positive correlation between power and electric current, the subject to be adjusted for touch detection may be alternatively set to electric current instead of power level.

In addition to the sampling rates and the number of targets (referring to detection for touch or not, one finger detection, or multiple fingers detection, etc.) of touch detection, other configurations, such as different detection resolutions or accuracy, may be used instead to respond to the adjusted power level in different detection modes.

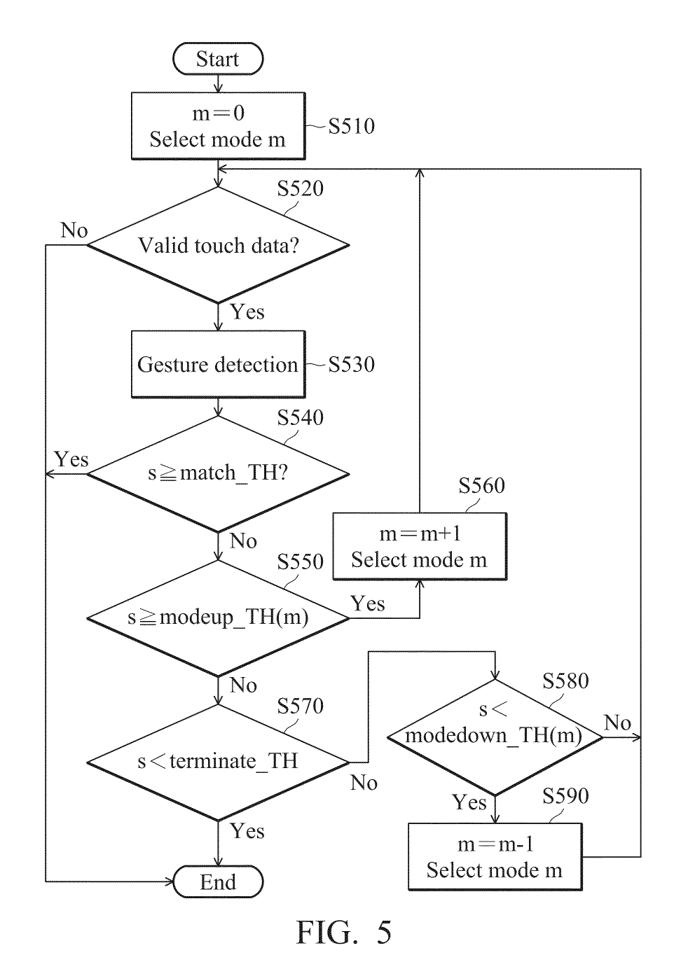

FIG. 5 is a flow chart illustrating adjustment of detection modes according to an embodiment of the invention. To begin, the detection mode (mode index is denoted as m) is initially configured as the detection mode 0 (step S510). Next, when a touch is detected, it is determined whether the touch data is valid (step S520), by noise filtering as mentioned above with respect to the block B320. If the touch data is not valid, the process ends. Otherwise, if the touch data is valid, gesture detection is performed to determine the similarity probability (denoted as s) according to the touch data and the predetermined gesture (step S530). Subsequently, it is determined whether the similarity probability is greater than or equal to the match threshold (denoted as match_TH) (step S540), and if so, a match is identified for the predetermined gesture and the process ends. Otherwise, if the similarity probability is less than the match threshold, it is determined whether the similarity probability is greater than or equal to the mode-up threshold for the current mode (denoted as modeup_TH(m)) (step S550).

Subsequent to step S550, if the similarity probability is greater than or equal to the mode-up threshold for the current mode, the detection mode is upgraded to the next level (step S560), and the process goes back to step S520 to wait for the next touch data generated for the same touch over time. Otherwise, if the similarity probability is less than the mode-up threshold for the current mode, it is determined whether the similarity probability is less than the termination threshold (denoted as terminate_TH) (step S570), and if so, the detection for the touch is terminated and the process ends. Otherwise, if the similarity probability is greater than or equal to the termination threshold, it is determined whether the similarity probability is less than the mode-down threshold for the current mode (denoted as modedown_TH(m)) (step S580).

Subsequent to step S580, if the similarity probability is less than the mode-down threshold for the current mode, the detection mode is downgraded to the previous level (step S590), and the process goes back to step S520 to wait for the next touch data generated for the same touch over time. Otherwise, if the similarity probability is greater than or equal to the mode-down threshold for the current mode, the process goes back to step S520 to wait for the next touch data generated for the same touch over time.

Although the detection mode is upgraded or downgraded one level at a time in the embodiment of FIG. 5, the detection mode may also be upgraded or downgraded for more than one level at a time, and the invention is not limited thereto.

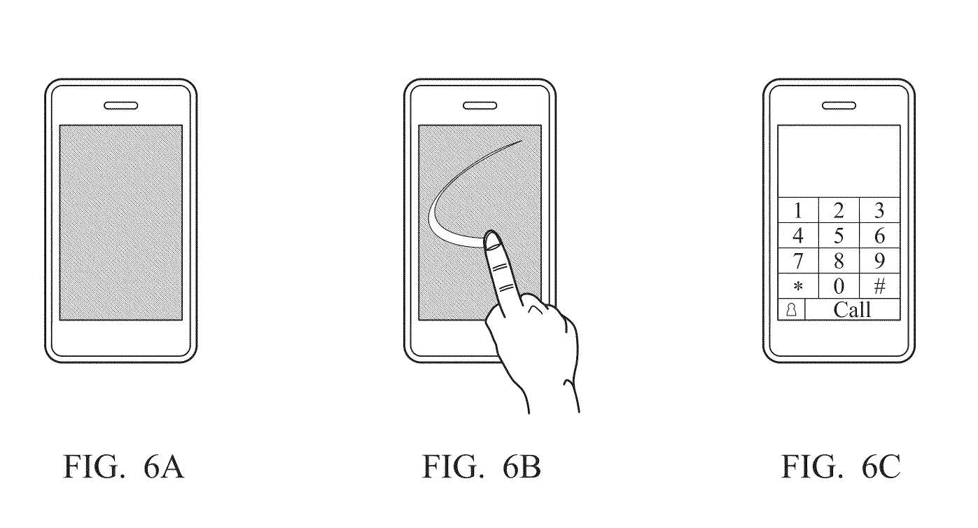

FIGS. 6A to 6C show schematic diagrams illustrating the waking of the touch screen of a smart phone from the sleep state in accordance with the embodiment of FIG. 4. In FIG. 6A, the touch screen of the smart phone is in the sleep state. Specifically, the display function of the touch screen is off while the touch-detection function operates in the lazy mode in which only a low power level (also called standby power level) sustainable for low accuracy detection (i.e., whether the touch screen is touched or not) is provided. In FIG. 6B, a user's finger touches the touch screen and the touch continues for a period of time to form a gesture similar to the letter ‘C’. When the touch is first detected, i.e., at the very beginning of the gesture, the detection mode switches from the lazy mode to the gesture mode 0 in which the provided power level is increased for one finger detection with a low sampling rate. As the touch continues over time and the gesture remains fairly similar to the letter ‘C’, the detection mode switches from the gesture mode 0 to gesture mode 1, and further switches from the gesture mode 1 to gesture mode 2, thereby increasing the power level more for better quality of accuracy of one finger detection with higher sampling rate. As the touch and gesture detection yields a match, the display function of the touch screen is turned on and the call Application (APP) is launched according to the gesture matching the letter ‘C’, as shown in FIG. 6C.

In another embodiment, there may be more than one predetermined gesture. For example, the letter ‘e’ may be configured as a predetermined gesture for waking the display function of the touch screen and then launching the browser APP, or the letter ‘w’ may be configured as a predetermined gesture for just waking the display function of the touch screen without further launching any APP, or others.

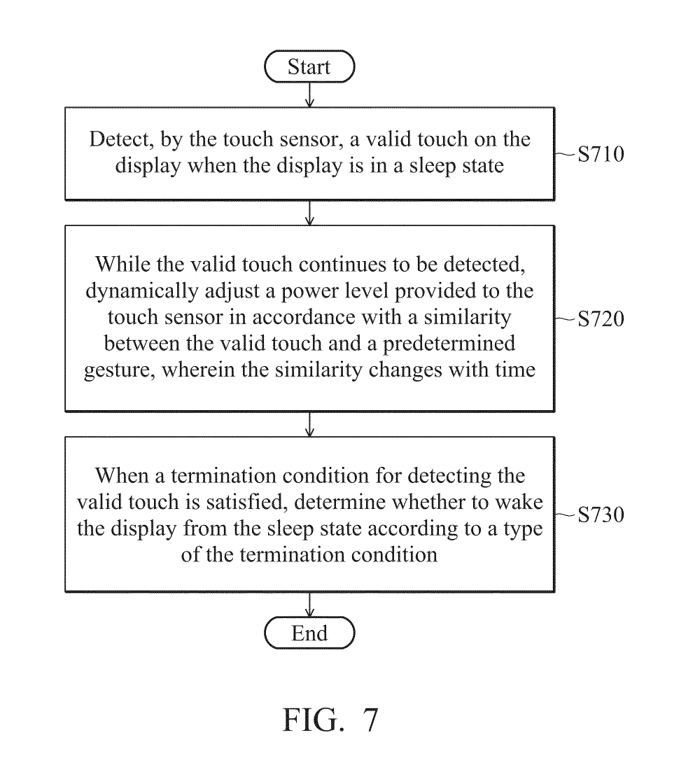

FIG. 7 is a flow chart illustrating the method for waking a display with a dynamically adjustable power level to detect touches thereon according to another embodiment of the invention. In this embodiment, the method is applied to a portable electronic device comprising a display with a touch sensor disposed thereon or thereunder. To begin, the touch sensor detects a valid touch on the display when the display is in a sleep state (step S710). Specifically, the touch sensor detects the touch first and then determines whether the touch is valid as described in step S520 of FIG. 5. That is, the invalid touches will be ruled out by the touch sensor. Next, while the valid touch continues to be detected, the portable electronic device dynamically adjusts a power level provided to the touch sensor in accordance with a similarity between the valid touch and a predetermined gesture, wherein the similarity changes with time (step S720). For example, the power level may be set to a minimum value (or a maximum value) right after the valid touch is determined to be detected, wherein the minimum value is higher than the standby power level. Then, the power level may be dynamically adjusted to be increased or decreased between the maximum value and the minimum value based on how similar the valid touch is to the predetermined gesture, as described in steps S550˜S560 or steps S580˜S590 of FIG. 5. After that, when a termination condition for detecting the valid touch is satisfied, the portable electronic device determines whether to wake the display from the sleep state according to a type of the termination condition (step S730). In one embodiment, the type of the termination condition refers to a positive match between the valid touch and the predetermined gesture (i.e., the “YES” branch of step S540 in FIG. 5), so it is determined to wake the display from the sleep state. In another embodiment, the type of the termination condition refers to a negative match between the valid touch and the predetermined gesture (i.e., the “YES” branch of step S570 in FIG. 5), so it is determined not to wake the display from the sleep state.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

Note that use of ordinal terms such as “first”, “second”, “third”, etc., in the claims to modify a claim element does not by itself connote any priority, precedence, or order of one claim element over another or the temporal order in which acts of the method are performed, but are used merely as labels to distinguish one claim element, having a certain name, from another element, having the same name (except for use of ordinal terms), to distinguish the claim elements.

What is claimed is:

1. A portable electronic device, comprising:
a touch sensor, disposed on or under a display, using a power level to generate first touch data for a touch detected thereon when the display is in a sleep state; and
a processing unit, configuring the touch sensor to increase the power level to generate second touch data for the touch when determining that the touch corresponds to a predetermined gesture with a first similarity probability greater than a first threshold according to the first touch data, and waking the display from the sleep state when determining that the touch corresponds to the predetermined gesture with a second similarity probability greater than a second threshold according to the second touch data, wherein the second threshold is greater than the first threshold.

2. The portable electronic device of claim 1, wherein, prior to using the power level to generate the first touch data, the touch sensor is configured to use a standby power level lower than the power level for detecting whether the display is touched.

3. The portable electronic device of claim 1, wherein the processing unit further configures the touch sensor to terminate the touch detection when the first similarity probability or the second similarity probability is lower than a third threshold, wherein the third threshold is lower than the first threshold.

4. The portable electronic device of claim 1, wherein the processing unit further configures the touch sensor to terminate the touch detection when determining that the touch is not detected within a first area on the display, or that a second area covered by the touch on the display is not within a predetermined range.

5. The portable electronic device of claim 1, wherein, in response to the power level being increased,
one or a combination of a sampling rate of the touch detection, a number of targets of the touch detection, and a quality of the touch detection is increased.

6. The portable electronic device of claim 1, wherein the processing unit further launches an Application (APP) corresponding to the predetermined gesture, after waking the display from the sleep state.

7. The portable electronic device of claim 1, wherein the processing unit further configures the touch sensor to revert the power level back to where it hasn't been increased to regenerate the first touch data for the touch, when determining that the touch corresponds to the predetermined gesture with the second similarity probability lower than the second threshold but greater than the first threshold according to the second touch data.

8. The portable electronic device of claim 1, wherein, prior to configuring the touch sensor to increase the power level to generate the second touch data, the processing unit further configures the touch sensor to increase the power level to generate third touch data for the touch when determining that the touch corresponds to the predetermined gesture with the first similarity probability greater than a fourth threshold and lower than the first threshold according to the first touch data, wherein the determining of that the touch corresponds to the predetermined gesture with the first similarity probability greater than the first threshold is performed further according to the third touch data.

9. A method for a portable electronic device to wake a display with a touch sensor disposed thereon or thereunder, the method comprising:
configuring the touch sensor to use a power level to generate first touch data for a touch detected on the display when the display is in a sleep state;
configuring the touch sensor to increase the power level to generate second touch data for the touch when determining that the touch corresponds to a predetermined gesture with a first similarity probability greater than a first threshold according to the first touch data; and
waking the display from the sleep state when determining that the touch corresponds to the predetermined gesture with a second similarity probability greater than a second threshold according to the second touch data, wherein the second threshold is greater than the first threshold.

10. The method of claim 9, further comprising:
prior to configuring the touch sensor to use the power level to generate the first touch data, configuring the touch sensor to use a standby power level lower than the power level for detecting whether the display is touched.

11. The method of claim 9, further comprising:
configuring the touch sensor to terminate the touch detection when the first similarity probability or the second similarity probability is lower than a third threshold, wherein the third threshold is lower than the first threshold.

12. The method of claim 9, further comprising:
configuring the touch sensor to terminate the touch detection when determining that the touch is not detected within a first area on the display, or that a second area covered by the touch on the display is not within a predetermined range.

13. The method of claim 9, wherein, in response to the power level being increased,
one or a combination of a sampling rate of the touch detection, a number of targets of the touch detection, and a quality of the touch detection is increased.

14. The method of claim 9, further comprising:
launching an Application (APP) corresponding to the predetermined gesture, after waking the display from the sleep state.

15. The method of claim 9, further comprising:
configuring the touch sensor to revert the power level back to where it hasn't been increased to regenerate the first touch data for the touch, when determining that the touch corresponds to the predetermined gesture with the second similarity probability lower than the second threshold but greater than the first threshold according to the second touch data.

16. The method of claim 9, further comprising:
prior to configuring the touch sensor to increase the power level to generate the second touch data, configuring the touch sensor to increase the power level to generate third touch data for the touch when determining that the touch corresponds to the predetermined gesture with the first similarity probability greater than a fourth threshold and lower than the first threshold according to the first touch data,
wherein the determining of that the touch corresponds to the predetermined gesture with the first similarity probability greater than the first threshold is performed further according to the third touch data.

17. A method for a portable electronic device to wake a display with a touch sensor disposed thereon or thereunder, the method comprising:
detecting, by the touch sensor, a valid touch on the display when the display is in a sleep state;
while the valid touch continues to be detected, dynamically adjusting a power level provided to the touch sensor in accordance with a similarity between the valid touch and a predetermined gesture, wherein the similarity changes with time; and
when a termination condition for detecting the valid touch is satisfied, determining whether to wake the display from the sleep state according to a type of the termination condition.
